(19) United States
(12) Patent Application Publication
(10) Pub. No.: US 2012/0014733 A1
(43) Pub. Date: Jan. 19, 2012

(54) METHOD OF INCREASING COLORING STABILITY OF A RIBBON AND PRINTING DEVICE THEREOF

(76) Inventor: Li-Ting Tsai, Taipei City (TW)

(21) Appl. No.: 12/904,101

(22) Filed: Oct. 13, 2010

(30) Foreign Application Priority Data
Jul. 19, 2010 (TW) 099123694

(51) Int. Cl. B41J 31/09

(52) U.S. Cl. 400/237

(57) ABSTRACT

A method of increasing coloring stability of a ribbon includes forming a dye receiving layer on a first region of the ribbon, forming a plurality of dye regions on a second region of the ribbon, receiving target image data, conveying a print medium, transferring the dye receiving layer of the ribbon onto the print medium when conveying the print medium, and transferring the plurality of dye regions of the ribbon onto the print medium according to the target image data after the dye receiving layer of the ribbon is printed onto the print medium.

### BACKGROUND OF THE INVENTION

1. Field of the Invention

The present invention relates to a printing method and a printing device thereof, and more particularly, to a printing method capable of increasing coloring stability of a ribbon and a printing device thereof.

2. Description of the Prior Art

Due to the full tone printing performance, a dye sublimation printer becomes a trend in the printing market. The dye sublimation printer utilizes a thermal print head (TPH) to heat a ribbon, so that dyes on the ribbon is transferred from solid state into gaseous state for being formed on a print medium and for forming the full tone according to the heating period and the heating temperature.

A thermal sublimation card printer capable of printing images on various cards, such as an identification card, an entrance cards, and so on, is designed for satisfying user's demand. The conventional thermal sublimation card printer utilizes a driving mechanism, such as a roller, to convey the card to a position under a thermal print head, so that the thermal print head can transfer a dye region of the ribbon onto the card. After the dye region of the ribbon is transferred onto the card, the driving mechanism conveys the card to an initial position for executing next transfer of the other dye region of the ribbon.

However, adhesion of the dyes of the ribbon is affected by material of the print medium, and quality of the image formed on the print medium depends on the adhesive capacity of the dyes of the ribbon. The conventional ribbon utilizes various dyes to match the print medium with corresponding material, so as to improve the adhesive capacity of the ribbon affected by the surface property of the print medium. Therefore, as the print device prints data on different print medium, the ribbons having the corresponding dyes need to be installed inside the print device for printing, which is expensive and inconvenient.

### SUMMARY OF THE INVENTION

The present invention provides a printing method capable of increasing coloring stability of a ribbon and a printing device thereof for solving above drawbacks.

According to the claimed invention, a method of increasing coloring stability of a ribbon includes forming a dye receiving layer on a first region of the ribbon, forming a plurality of dye regions on a second region of the ribbon, receiving a target image datum, conveying a print medium, transferring the dye receiving layer of the ribbon onto the print medium when conveying the print medium, and transferring the plurality of dye regions of the ribbon onto the print medium according to the target image datum after the dye receiving layer of the ribbon is printed onto the print medium.

According to the claimed invention, transferring the dye receiving layer of the ribbon onto the print medium includes transferring the dye receiving layer of the ribbon onto a complete surface of the print medium.

According to the claimed invention, the method further includes transferring a protecting layer of the ribbon onto the print medium after the plurality of dye regions of the ribbon is transferred onto the print medium.

According to the claimed invention, the method further includes setting a correlation between the plurality of dye regions of the ribbon and the print medium according to the target image datum.

According to the claimed invention, forming the plurality of dye regions on the second region of the ribbon includes forming a yellow dye region, a magenta dye region, a cyan dye region, and a black dye region on the second region of the ribbon.

According to the claimed invention, forming the dye receiving layer on the first region of the ribbon includes forming the dye receiving layer made of vinyl chloride-vinyl acetate copolymer on the first region of the ribbon.

According to the claimed invention, the plurality of dye regions and the dye receiving layer of the ribbon are transferred onto the print medium by sublimation printing method.

According to the claimed invention, a print device includes a conveying unit for conveying a print medium, a ribbon comprising a first region whereon a dye receiving layer is formed and a second region whereon a plurality of dye regions is formed, a thermal print head for respectively transferring the dye receiving layer and the plurality of dye regions of the ribbon onto the print medium, and a control unit coupled to the conveying unit and the thermal print head for controlling the conveying unit to convey the print medium according to a target image datum, for controlling the thermal print head to transfer the dye receiving layer of the ribbon onto the print medium, and for controlling the thermal print head to transfer the plurality of dye regions of the ribbon onto the print medium after the dye receiving layer is transferred onto the print medium.

According to the claimed invention, the control unit is further for controlling the thermal print head to transfer the dye receiving layer of the ribbon onto a complete surface of the print medium.

According to the claimed invention, the control unit is further for setting a correlation between the plurality of dye regions of the ribbon and the print medium according to the target image datum.

According to the claimed invention, the ribbon further includes a protecting layer, and the control unit is further for controlling the thermal print head to transfer the protecting layer of the ribbon onto the print medium after the plurality of dye regions is transferred onto the print medium.

According to the claimed invention, the print device is a dye sublimation printer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a printing device according to a preferred embodiment of the present invention.

FIG. 2 is a diagram of a ribbon according to the preferred embodiment of the present invention.

FIG. 3 is a flow chart of a printing method according to the preferred embodiment of the present invention.

### DETAILED DESCRIPTION

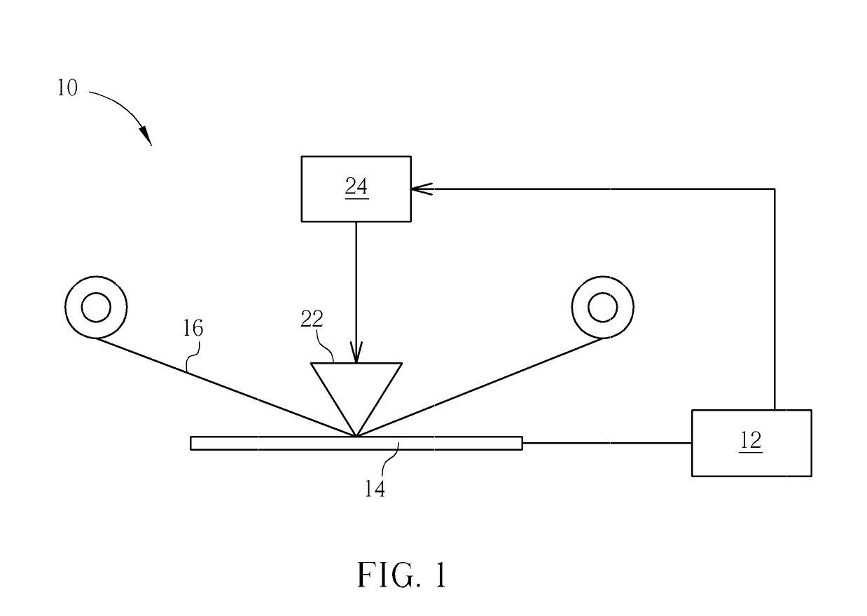

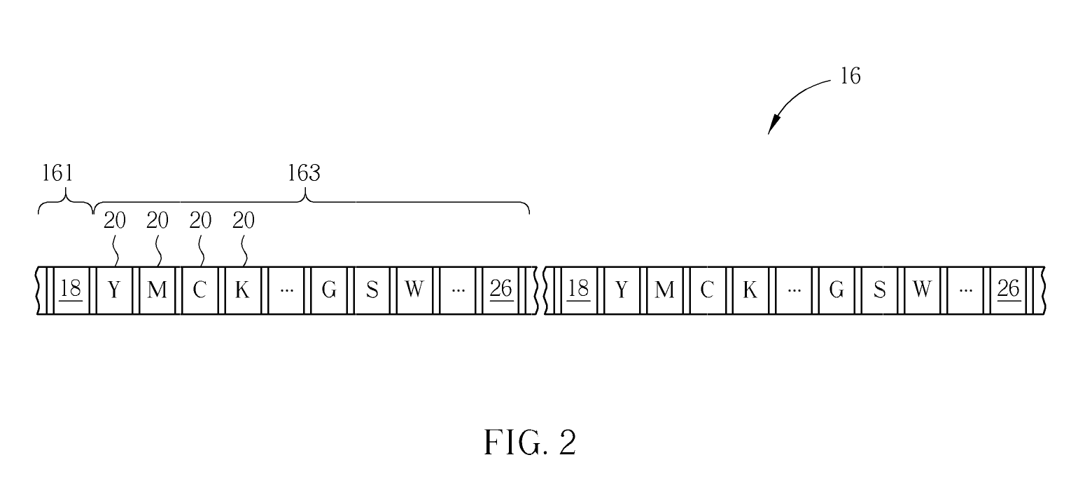

Please refer to FIG. 1. FIG. 1 is a diagram of a printing device 10 according to a preferred embodiment of the present invention. The printing device 10 can be a dye sublimation printer. The printing device 10 includes a conveying unit 12 for conveying a print medium 14. The conveying unit 12 can be a driving mechanism, which includes a motor, a roller, and so on. The printing device 10 further includes a ribbon 16. Please refer to FIG. 2. FIG. 2 is a diagram of the ribbon 16 according to the preferred embodiment of the present invention. The ribbon 16 includes at least one first region 161 and at least one second region 163. A dye receiving layer 18 is formed on the first region 161, and a plurality of dye regions 20 is formed on the second region 163. The printing device 10 further includes a thermal print head 22 for transferring the dye receiving layer 18 and the plurality of dye regions 20 of the ribbon 16 onto the print medium 14, respectively.

The printing device 10 further includes a control unit 24 coupled to the conveying unit 12 and the thermal print head 22 for controlling the conveying unit 12 to convey the print medium 14 according to a received target image datum. As the print medium 14 is conveyed, the control unit 24 further controls the thermal print head 22 to transfer the dye receiving layer 18 of the ribbon 16 onto the print medium 14. After the dye receiving layer 18 is transferred onto the print medium 14, the control unit 24 sets a correlation between the plurality of dye regions 20 of the ribbon 16 and the print medium 14 according to the target image datum, and then controls the thermal print head 22 to transfer the plurality of dye regions 20 of the ribbon 16 onto the print medium 14 whereon the dye receiving layer 18 is covered according to the correlation between the plurality of dye regions 20 of the ribbon 16 and the print medium 14. The plurality of dye regions 20 can include a yellow dye region, a magenta dye region, a cyan dye region, and a black dye region.

The dye receiving layer 18 can be made of vinyl chloride-vinyl acetate copolymer, which has advantages of preferable toughness and corrosion-resistibility of the vinyl chloride and high viscosity and plasticity of the vinyl acetate simultaneously. In addition, the vinyl chloride-vinyl acetate copolymer is easy to polymerize with other resin, such as alkyd resin, polyacetal, polyurethane, melamine resin, and so on, so that viscosity, toughness, and chemical resistance of the dye regions 20 on the print medium 14 can be improved. Therefore, the present invention can utilize the dye receiving layer 18 made of the vinyl chloride-vinyl acetate copolymer, which has preferable chemical resistance, moisture-proofing, and viscosity, to increase stability of the plurality of dye regions 20 adhered on the print medium 14. Besides, the dye receiving layer 18 can further include resin material made of hydroxyl and carboxyl, and the chemical resistance and moisture-tolerance of the dye receiving layer 18 can be increased via cross-linking agent, such as cyanic acid. Colors and material of the plurality of dye regions 20 are not limited to the above-mentioned embodiment and depend on design demand. For example, the plurality of dye regions 20 can further include golden color, silver color, white color, and so on, and depends on actual demand. Material and characteristic of the dye receiving layer 18 are not limited to the above-mentioned embodiment and depend on design demand.

It should be mentioned that the control unit 24 controls the thermal print head 22 to transfer the dye receiving layer 18 onto the complete surface of the print medium 14, so as to ensure that the plurality of dye regions 20 can be formed on anywhere of the print medium 14 via the dye receiving layer 18. In addition, the ribbon 16 can further include a protecting layer 26 formed on the second region 163. After the plurality of dye regions 20 is transferred onto the print medium 14, the control unit 24 can further control the thermal print head 22 to transfer the protecting layer 26 onto the print medium 14, so as to provide water-proofing and dust-proofing functions for the print medium 14. For example, the protecting layer 26 can be made of material having waterproof function, oilproof function, and anti-UV function, so as to prevent the dye regions from being oozed, faded, or polluted by moisture or oil sludge. The dye receiving layer 18, the plurality of dye regions 20, and the protecting layer 26 can be transferred onto the print medium 14 by sublimation printing method.

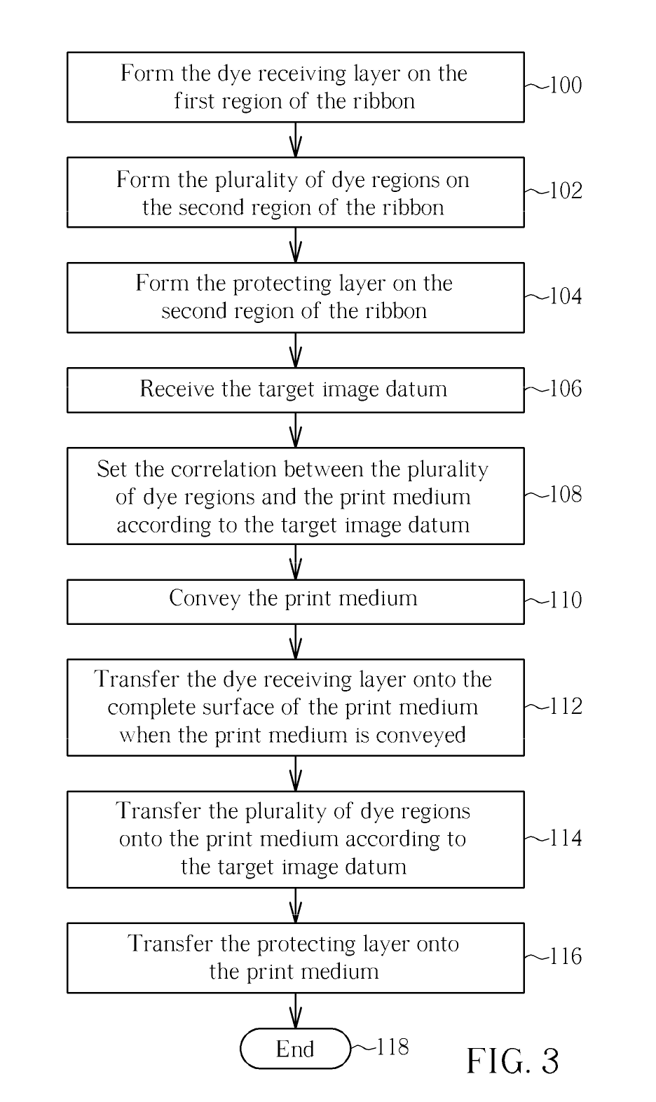

Please refer to FIG. 3. FIG. 3 is a flow chart of a printing method according to the preferred embodiment of the present invention. The printing method includes following steps:

Step 100: Form the dye receiving layer 18 on the first region 161 of the ribbon 16;

Step 102: Form the plurality of dye regions 20 on the second region 163 of the ribbon 16;

Step 104: Form the protecting layer 26 on the second region 163 of the ribbon 16;

Step 106: Receive the target image datum;

Step 108: Set the correlation between the plurality of dye regions 20 and the print medium 14 according to the target image datum;

Step 110: Convey the print medium 16;

Step 112: Transfer the dye receiving layer 18 onto the complete surface of the print medium 14 when the print medium 16 is conveyed;

Step 114: Transfer the plurality of dye regions 20 onto the print medium 14 according to the target image datum after the dye receiving layer 18 has been transferred onto the print medium 14;

Step 116: Transfer the protecting layer 26 onto the print medium 14 after the plurality of dye regions 20 has been transferred onto the print medium 14;

Step 118: End.

A detailed description of the printing method is introduced as follows. The dye receiving layer 18 can be formed on the first region 161 of the ribbon 16, and the plurality of dye regions 20 and the protecting layer 26 can be formed on the second region 163 of the ribbon 16. The dye receiving layer 18 is for increasing coloring stability of the dyes adhering to the print medium 14. The protecting layer 26 is for covering the print medium 14 whereon the dye receiving layer 18 and the plurality of dye regions 20 are formed for waterproof function and dirtproof function. And then, the print device 10 starts to work after the ribbon 16 whereon the dye receiving layer 18, the plurality of dye regions 20, and the protecting layer 26 are formed is installed inside the print device 10. First, the control unit 24 of the print device 10 receives the target image datum, and sets the correlation between the plurality of dye regions 20 of the ribbon 16 and the print medium 14 according to the target image datum. When the conveying unit 12 conveys the print medium 14 in a predetermined speed, the control unit 24 controls the thermal print head 22 to transfer the dye receiving layer 18, as a substrate, onto the complete surface of the print medium 14. Then, the control unit 24 controls the thermal print head 22 to respectively transfer the plurality of dye regions 20, such as the yellow dye region, the magenta dye region, the cyan dye region, and the black dye region, onto the corresponding positions of the print medium 14, so that the plurality of dye regions 20 can be cohered on the print medium 14 via the chemical stability of the dye receiving layer 18, and a printing image can be formed. Finally, the control unit 26 controls the thermal print head 22 to transfer the protecting layer 26 onto the print medium 14, which means the protecting layer 26 covers the printing image, for protecting the printing image from being oozed, faded, or polluted by moisture or oil sludge.

Comparing to the prior art, the present invention can utilize the common print device to print the photographs on all kinds of print medium by various material of the dyes, and does not have limitation that each print medium is merely suitable for the dye made of corresponding material. The present invention forms the dye receiving layer on the ribbon, and transfers the dye receiving layer onto the complete surface of the print medium, so that the dye regions of the ribbon can be transferred onto the print medium via the dye receiving layer stably. Therefore, the present invention can reduce the printing period, economize the printing cost, and increase the printing quality and the operational convenience.

Those skilled in the art will readily observe that numerous modifications and alterations of the device and method may be made while retaining the teachings of the invention.

What is claimed is:

1. A method of increasing coloring stability of a ribbon comprising:
forming a dye receiving layer on a first region of the ribbon;
forming a plurality of dye regions on a second region of the ribbon;
receiving a target image datum;
conveying a print medium;
transferring the dye receiving layer of the ribbon onto the print medium when conveying the print medium; and
transferring the plurality of dye regions of the ribbon onto the print medium according to the target image datum after the dye receiving layer of the ribbon is printed onto the print medium.

2. The method of claim 1, wherein transferring the dye receiving layer of the ribbon onto the print medium comprises transferring the dye receiving layer of the ribbon onto a complete surface of the print medium.

3. The method of claim 1 further comprising:
transferring a protecting layer of the ribbon onto the print medium after the plurality of dye regions of the ribbon is transferred onto the print medium.

4. The method of claim 1 further comprising:
setting a correlation between the plurality of dye regions of the ribbon and the print medium according to the target image datum.

5. The method of claim 1, wherein forming the plurality of dye regions on the second region of the ribbon comprises forming a yellow dye region, a magenta dye region, a cyan dye region, and a black dye region on the second region of the ribbon.

6. The method of claim 1, wherein forming the dye receiving layer on the first region of the ribbon comprises forming the dye receiving layer made of vinyl chloride-vinyl acetate copolymer on the first region of the ribbon.

7. The method of claim 1, wherein the plurality of dye regions and the dye receiving layer of the ribbon are transferred onto the print medium by sublimation printing method.

8. A print device comprising:
a conveying unit for conveying a print medium;
a ribbon comprising a first region whereon a dye receiving layer is formed and a second region whereon a plurality of dye regions is formed;
a thermal print head for transferring the dye receiving layer and the plurality of dye regions of the ribbon onto the print medium, respectively; and
a control unit coupled to the conveying unit and the thermal print head for controlling the conveying unit to convey the print medium according to a target image datum, for controlling the thermal print head to transfer the dye receiving layer of the ribbon onto the print medium, and for controlling the thermal print head to transfer the plurality of dye regions of the ribbon onto the print medium after the dye receiving layer is transferred onto the print medium.

9. The print device of claim 8, wherein the control unit is further for controlling the thermal print head to transfer the dye receiving layer of the ribbon onto a complete surface of the print medium.

10. The print device of claim 8, wherein the control unit is further for setting a correlation between the plurality of dye regions of the ribbon and the print medium according to the target image datum.

11. The print device of claim 8, wherein the ribbon further comprises a protecting layer, and the control unit is further for controlling the thermal print head to transfer the protecting layer of the ribbon onto the print medium after the plurality of dye regions is transferred onto the print medium.

12. The print device of claim 8, wherein the plurality of dye regions comprises a yellow dye region, a magenta dye region, a cyan dye region, and a black dye region.

13. The print device of claim 8, wherein the dye receiving layer is made of vinyl chloride-vinyl acetate copolymer.

14. The print device of claim 8, being a dye sublimation printer.
